(19) United States
(12) Patent Application Publication
(10) Pub. No.: US 2011/0160693 A1
(43) Pub. Date: Jun. 30, 2011

(54) MEDICATION-CONTAINING CONTAINER

(75) Inventor: Masaomi Imai, Yamanashi-ken (JP)

(73) Assignee: Terumo Kabushiki Kaisha, Shibuya-ku, TOKYO (JP)

(21) Appl. No.: 13/002,727

(22) PCT Filed: Jul. 2, 2009
(86) PCT No.: PCT/JP2009/062103

§ 371 Date: Feb. 16, 2011

(30) Foreign Application Priority Data
Jul. 9, 2008 (JP) 2008-179312
Sep. 25, 2008 (JP) 2008-246798

(51) Int. Cl. A61J 1/05

(52) U.S. Cl. 604/416

(57) ABSTRACT

A medication-containing container includes a container body having at its front end side a mouth section through which liquid can enter and exit the container body and made of a flexible material, and also with a medication contained in the container body and dissolved by the liquid flowing into the container body. In the medication-containing container, the container body has two flat sections facing each other with a gap therebetween in an initial state in which the container body is not filled with liquid, a frame section on the outer peripheries of the flat sections, and an easily deformable section interconnecting at least either of the pair of flat section and the frame section. When the container body is filled with liquid, the easily deformable section deforms to separate the flat sections from each other, increasing the gap between the flat sections to increase the volume of the container body.

### TECHNICAL FIELD

The present invention relates to a medication-containing container.

### BACKGROUND ART

Powdery medications which are dangerous if erroneously touched by a medical worker, such as carcinostatic or immunosuppressant, are preliminarily contained in flexible medication bags in some cases. As the medication-containing bag, there can be used a bag produced by fusion-bonding edge portions of two sheet materials (see, for example, Patent Document 1). The powdery medication contained in the medication-containing bag described in Patent Document 1 is dissolved with a dissolving liquid which has been introduced into the medication-containing bag through a mouth section of the bag, and the resulting solution is used.

In Patent Document 1, in the medication-containing bag in the state where no dissolving liquid is contained in the bag, most of the inner surfaces of the sheet materials are in close contact with each other. Therefore, when the dissolving liquid is to be introduced into the medication-containing bag via the mouth section of the bag, it may be impossible to cause the dissolving liquid to flow into the bag smoothly, and thus it may be impossible to sufficiently fill the bag with the dissolving liquid. Also, in the medication-containing bag described in Patent Document 1, when the medication is located near the fusion-bonded portion of the sheet materials, it may be impossible for the dissolving liquid to reach the vicinity of the fusion-bonded portion, though depending on the amount of the dissolving liquid with which the medication-containing bag is filled. Consequently, there is a possibility that the medication near the fusion-bonded portion cannot make contact with the dissolving liquid and, hence, cannot be dissolved by the dissolving liquid.
Patent Document 1: Japanese Laid-Open Patent Publication No. 2006-206118

### DISCLOSURE OF INVENTION

It is an object of the present invention to provide a medication-containing container in which a liquid can be easily introduced into a container body thereof, and a medication can be reliably dissolved with the liquid contained in the container.

In order to attain the above object, according to the present invention, there is provided

a medication-containing container including a container body having, at a distal end side thereof, a mouth section through which a liquid can flow into and out of the container body, the container body being made of a flexible material, and a medication contained in the container body and which is dissolved with the liquid that has flowed into the container body through the mouth section,

wherein the container body is integrally molded, and when the liquid is introduced into the container body, the container body deforms and increases in volume.

Thus, since the container body increases in volume when the liquid is introduced into the container body, the liquid can be easily introduced into the container body. Additionally, in this case, the container body can be sufficiently filled with the liquid and, therefore, the medication can be reliably dissolved with the liquid contained in the container body.

Also, in order to attain the above object, according to the present invention, there is provided

a medication-containing container including a container body having, at a distal end side thereof, a mouth section through which a liquid can flow into and out of the container body, the container body being made of a flexible material, and a medication contained in the container body and which is dissolved with the liquid that has flowed into the container body through the mouth section;

wherein the container body includes:

a pair of flat sections being flat and facing each other with a gap therebetween in an initial state in which no liquid is contained in the container body,

a frame section provided on outer peripheries of the flat sections, and

an easily-deformable section which interconnects the frame section and at least one of the flat sections, and which is easily deformable; and

when the liquid is introduced into the container body, the easily-deformable section deforms to cause the flat sections to separate further from each other than in the initial state, so that the container body increases in volume.

Thus, since the container body increases in volume when the liquid is introduced into the container body, the liquid can be easily introduced into the container body. Additionally, in this case, the container body can be sufficiently filled with the liquid and, therefore, the medication can be reliably dissolved with the liquid contained in the container body.

In addition, in the medication-containing container according to the present invention, preferably, in the initial state, each of the flat sections is located within a range of the width of the frame section in side view.

Thus, the medication-containing container in the initial state is flat and, notwithstanding the flat shape, the medication-containing container can be reliably filled with the liquid.

Further, in the medication-containing container according to the present invention, preferably, the container body is formed such that the average thickness of a portion thereof where the frame section is formed, is smaller than the average thickness of portions thereof where the flat sections are formed.

Thus, the easily-deformable section can deform more preferentially (easily) than the flat sections and the frame section.

In addition, in the medication-containing container according to the present invention, preferably, the container body is formed such that that the average thickness of a portion thereof where the easily-deformable section is formed, is smaller than the average thickness of a portion thereof where the frame section is formed.

Thus, the easily-deformable section can deform more preferentially (easily) than the flat sections and the frame section.

Still further, in the medication-containing container according to the present invention, preferably, the container body further has flow direction regulating means for regulating the flow direction of the liquid that has flowed into the container body through the mouth section.

Thus, the medication dissolved with the liquid can be recovered speedily.

In addition, in the medication-containing container according to the present invention, preferably, the flow direction regulating means comprises at least one groove extending from the distal end side to a proximal end side in an inner portion of at least one of the flat sections.

Thus, the medication dissolved with the liquid can be recovered speedily.

Further, in the medication-containing container according to the present invention, preferably, the mouth section is fitted with a valve body made of an elastic material and which has an opening-closing section which is openable and closable.

Thus, the liquid or the like can be reliably prevented from flowing out through the mouth section unwillingly.

In addition, in the medication-containing container according to the present invention, preferably, the size of the gap between the flat sections is constant over the range from the distal end side to the proximal end side, in the initial state.

Thus, the liquid flowing in through the mouth section can pass through the gap. Therefore, the liquid can reach a proximal end portion of the container body easily and reliably. In other words, the container body can be filled with the liquid easily and reliably. Consequently, the medication can make contact with the liquid and, hence, is dissolved with the liquid.

Also, in the medication-containing container according to the present invention, preferably, the medication is located mainly in a space surrounded by an inner surface of the frame section.

Thus, in a case where the liquid flows more preferentially through the space than through the gap, the medication can reliably make contact with the liquid and, hence, is dissolved with the liquid.

In addition, in the medication-containing container according to the present invention, preferably, the frame section surrounds the whole peripheries of the flat sections.

Thus, the shape of the medication-containing container in the initial state is maintained and, therefore, the medication-containing container expands easily when the liquid is introduced into the container. In addition, the shape of the medication-containing container after expansion is also maintained. As a result, for example, the medication-containing container is easy to grip.

Further, in the medication-containing container according to the present invention, preferably, the frame section gradually decreases in width toward the proximal end direction.

Thus, the volume of the container body in the initial state can be made smaller.

In addition, in the medication-containing container according to the present invention, preferably, the groove has a portion which varies in at least one of depth and width from the distal end side to the proximal end side.

Thus, when the liquid flows in through the mouth section, the liquid can be guided into the groove reliably, so that the liquid can pass preferentially through the groove.

Also, in the medication-containing container according to the present invention, preferably, in the initial state, the medication is located mainly in the groove.

Thus, the medication can be reliably dissolved with the liquid guided into the groove.

In addition, in the medication-containing container according to the present invention, preferably, inner portions of the flat sections are hydrophilic.

Thus, the liquid can easily pass through the gap.

Further, in the medication-containing container according to the present invention, preferably, the container body is produced by integral molding.

Thus, an inner surface of the container body can be made smooth.

In addition, in the medication-containing container according to the present invention, preferably, the container body is produced by blow-molding.

Thus, an inner surface of the container body can be made smooth.

Further, in the medication-containing container according to the present invention, preferably, the medication is freeze-dried.

Thus, the medication can be reliably dried, irrespective of the kind of the medication.

### BRIEF DESCRIPTION OF DRAWINGS

FIG. 1 is a perspective view (showing an initial state) of a first embodiment of the medication-containing container according to the present invention.

FIG. 2 is a perspective view (showing a liquid-filled state) of the first embodiment of the medication-containing container according to the present invention.

FIG. 3 is a sectional view taken along line A-A of FIG.

FIG. 4 is a sectional view taken along line B-B of FIG.

FIG. 5 is a sectional view taken along line C-C of FIG.

FIG. 6 is a sectional view taken along line D-D of FIG. 2.

FIG. 7 is a perspective view of a second embodiment of the medication-containing container according to the present invention.

FIG. 8 is a sectional view taken along line E-E of FIG. 7.

FIG. 9 is a perspective view of a third embodiment of the medication-containing container according to the present invention.

FIG. 10 is a sectional view taken along line F-F of FIG. 9.

FIG. 11 is a sectional perspective view of a fourth embodiment of the medication-containing container according to the present invention.

FIG. 12 is a longitudinal sectional view of a fifth embodiment of the medication-containing container according to the present invention.

FIG. 13 is a cross-sectional view of the fifth embodiment of the medication-containing container according to the present invention.

FIG. 14 is a longitudinal sectional view of a sixth embodiment of the medication-containing container according to the present invention.

### DESCRIPTION OF THE EMBODIMENTS

Now, a medication-containing container according to the present invention will be described in detail below, based on preferred embodiments shown in the accompanying drawings.

### First Embodiment

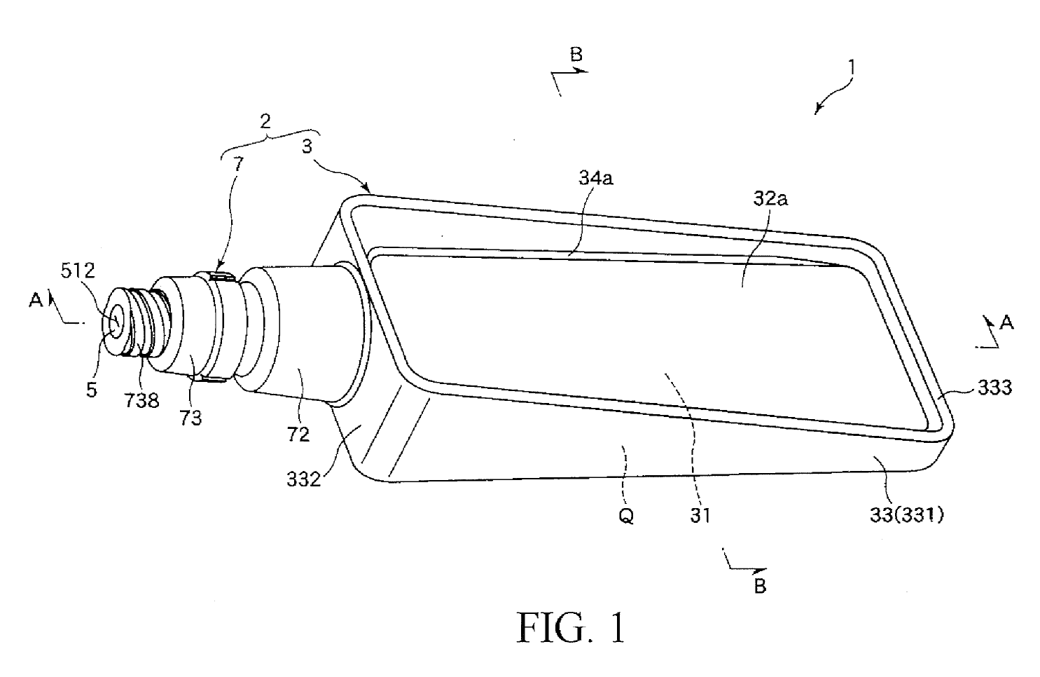

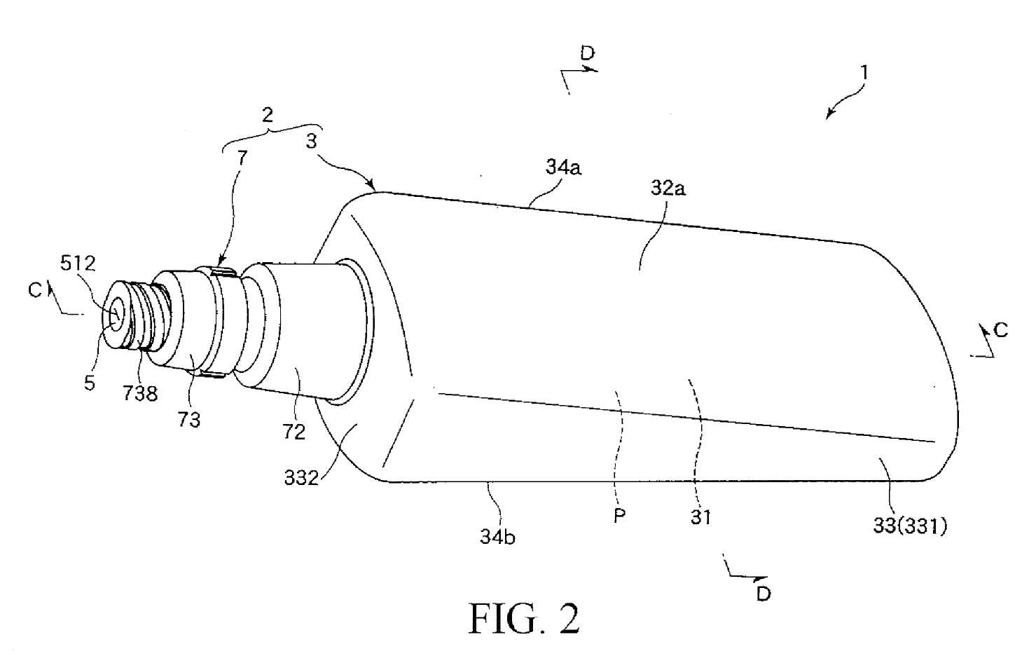

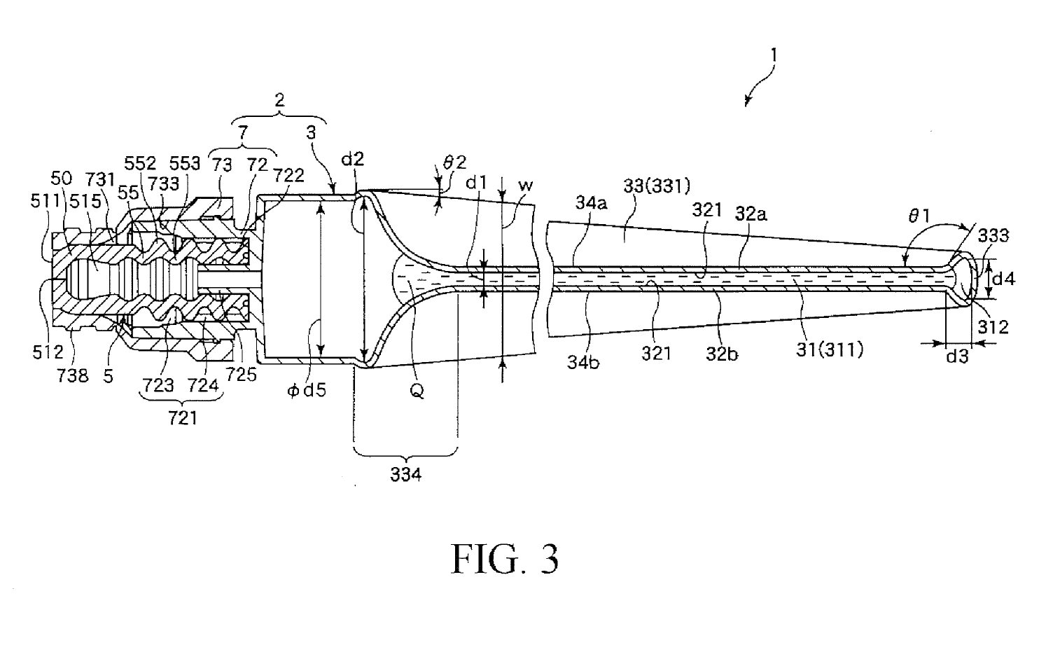

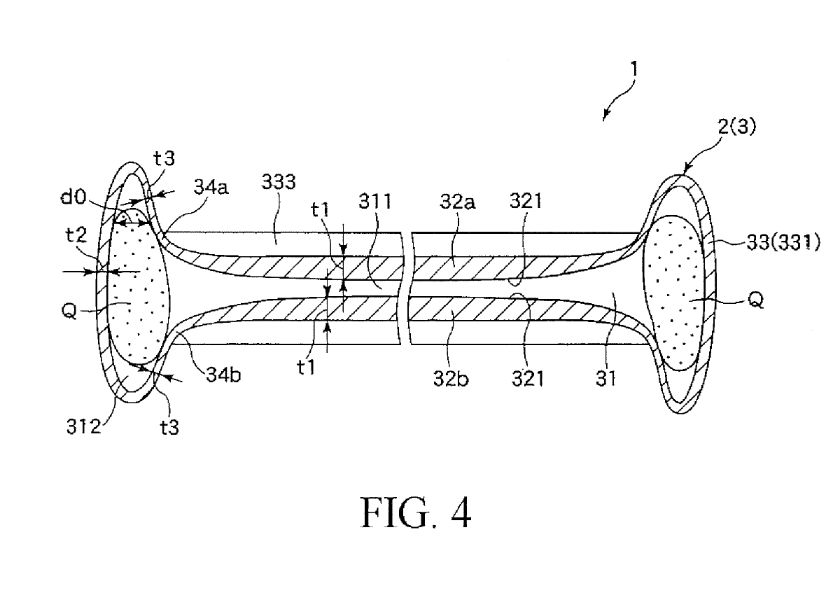

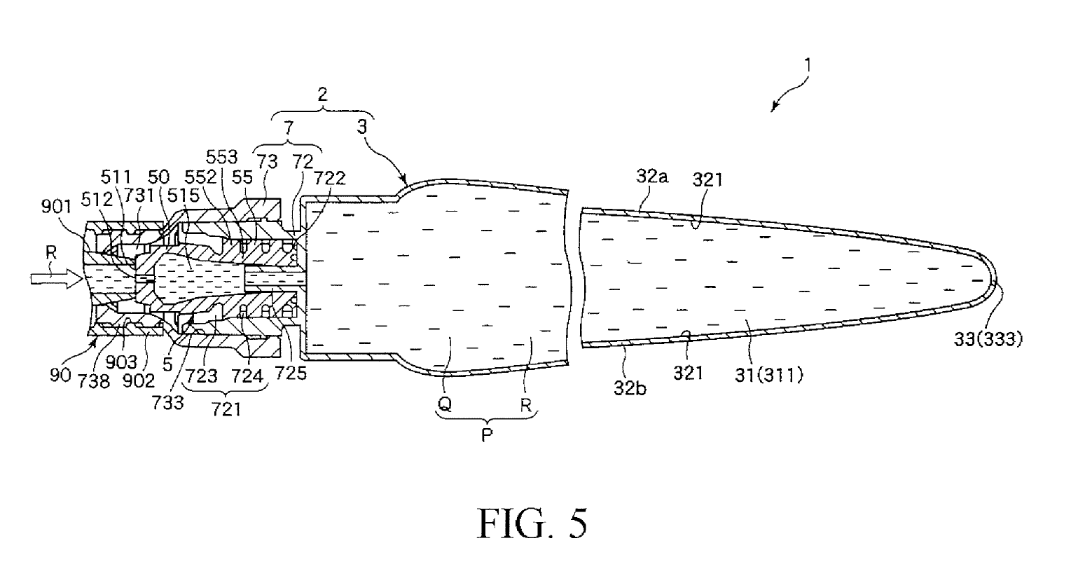

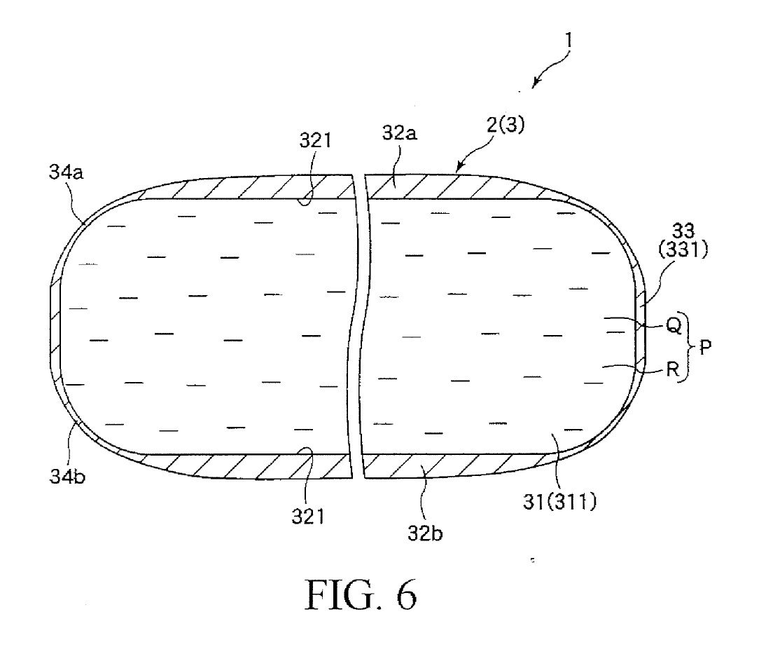

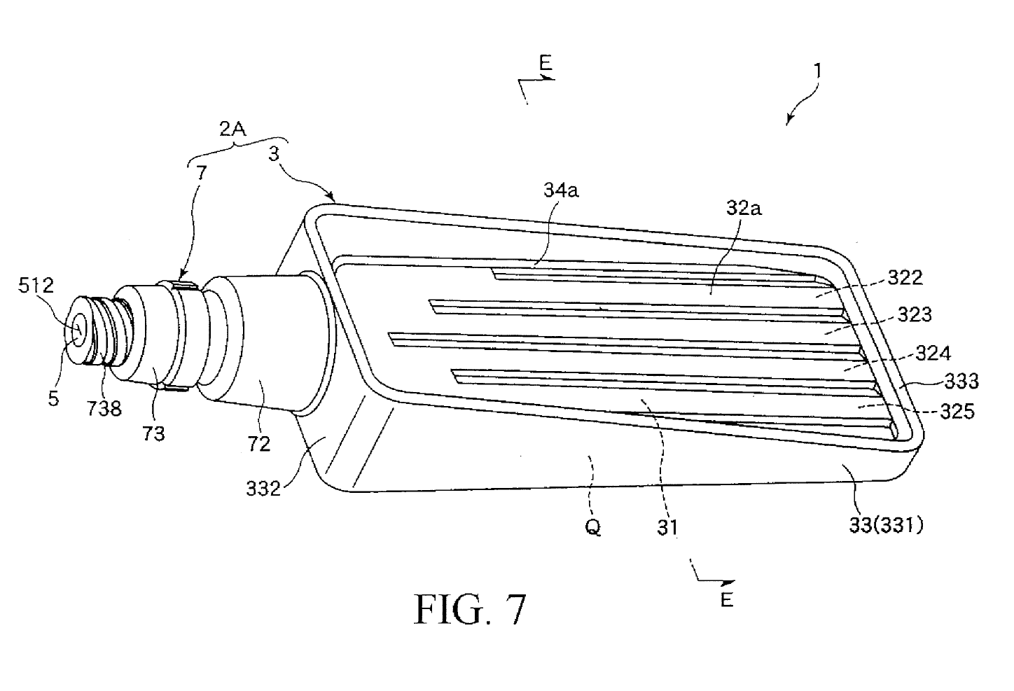

FIGS. 1 and 2 are perspective views (FIG. 1 being a view showing an initial state, and FIG. 2 being a view showing a liquid-filled state) of a first embodiment of the medication-containing container according to the present invention; FIG. 3 is a sectional view taken along line A-A of FIG. 1; FIG. 4 is a sectional view taken along line B-B of FIG. 1; FIG. 5 is a sectional view taken along line C-C of FIG. 2; and FIG. 6 is a sectional view taken along line D-D of FIG. 2. Incidentally, in the following, for convenience of description, the right side in FIGS. 1 to 3 and 5 (and in FIGS. 7, 9, 11, 12 and 14, also) will be referred to as “proximal (end),” and the left side as “distal (end).” Similarly, the upper side in FIGS. 1 to 6 (and in FIGS. 7 to 14, also) will be referred to as “upper” or “upper side,” and the lower side as “lower” or “lower side.”

A medication-containing container shown in FIGS. 1 and 2 is composed of a hollow container body 2, and a powdery medication Q contained in the container body 2. The medication Q is preliminarily contained in the container body 2 in an initial state (unused state (see FIG. 1)) of the medication-containing container 1. The medication Q is dissolved with a dissolving liquid (liquid) R introduced (injected) through a mouth section 7 of the container body 2, to be used in the dissolved state. Hereinafter, a substance obtained by dissolving a medication Q with a dissolving liquid R will be referred to as “a medicinal liquid P.” In addition, the condition in which the container body 2 is filled with a dissolving liquid R will be referred to as “a dissolving liquid-filled state (see FIG. 2).”

The container body 2 is composed of a barrel section 3 which is expandable and contractible so as to change the volume of an internal space 31, and the mouth section 7 provided at a distal end portion of the barrel section 3. In the following description, the description is about the “initial state” unless otherwise specified. Incidentally, the volume of the internal space 31 in the initial state is not particularly limited, and is, for example, preferably 1 to 50 mL, more preferably 3 to 30 mL.

As shown in the drawings, the barrel section 3 has a pair of flat sections 32a and 32b which are flat in shape, a frame section 33 provided on the outer peripheral side (outer peripheries) of the flat sections 32a and 32b, and an easily-deformable sections 34a and 34b for interconnecting the flat sections 32a and 32b with the frame section 33.

The flat sections 32a and 32b are long plate-like in shape (substantially rectangular in plan view). The flat section 32a and the flat section 32b face each other with a gap 311 therebetween, namely, with their inner surfaces 321 not in contact with each other. As shown in FIG. 3, in the initial state in which the container body 2 is not yet filled with the dissolving liquid R, the size (gap distance) of the gap 311 is constant along the longitudinal direction of the medication-containing container 1 (over the range from the distal end side to the proximal end side). This ensures that the dissolving liquid R flowing into the container body through the mouth section 7 can pass through the gap 311 and, hence, spread to a proximal end portion of the medication-containing container 1 (container body 2) easily and reliably; namely, filling with the dissolving liquid R can be achieved easily and reliably. Consequently, the medication Q can make contact with the dissolving liquid R and, hence, is dissolved with the dissolving liquid R.

Incidentally, the gap distance d1 in the initial state is not particularly limited, and is, for example, preferably 0.5 to 25 mm, more preferably 1 to 15 mm. With the gap distance d1 within such a numerical value range, the medication-containing container 1 can be produced stably in the case of producing the medication-containing container 1 by blow-molding.

In addition, since the flat section 32a and the flat section 32b are already separate from each other in the initial state, upon flowing of the dissolving liquid R into the container body 2, the dissolving liquid R can easily push the flat sections 32a and 32b separate from each other. Thus, in the dissolving liquid-filled state, the flat section 32a is moved upward whereas the flat section 32b is moved downward, so that the flat section 32a and the flat section 32b are spaced further from each other than in the initial state (see FIGS. 5 and 6). As a result, the internal space 31 of the container body 2 (barrel section 3) increases, so that a sufficient amount of the dissolving liquid R can be contained in the internal space 31. Incidentally, the flat sections 32a and 32b are substantially hardly deformed when separated from each other (see FIG. 6).

Also, the inner surfaces 321 (inside portions) of the flat sections 32a and 32b may be subjected to a hydrophilic treatment. As a result, the inner surfaces 321 are hydrophilic, which permits the dissolving liquid R to easily pass through the gap 311. In addition, when the medicinal liquid P (formed by dissolution of the medication Q with the dissolving liquid R) is sucked in through the mouth section 7, the medicinal liquid P can flow in the barrel section 3 smoothly, so that the sucking operation can be carried out easily. Further, the medication Q can be reliably prevented or restrained from adhering to the inner surfaces 321 of the flat sections 32a and 32b. Incidentally, the process for applying a hydrophilic treatment to the inner surfaces 321 of the flat sections 32a and 32b is not particularly limited; examples of the process may include a plasma treatment process.

As shown in FIGS. 1 and 2, the frame section 33 is provided on the outer periphery side of the flat sections 32a, 32b. The frame section 33 surrounds the whole peripheries of the flat sections 32a, 32b. As a result, the shape of the medication-containing container 1 in the initial state is maintained, so that the medication-containing container 1 expands easily when filled with the dissolving liquid R. In addition, the shape of the medication-containing container 1 after expansion (in the dissolving liquid-filled state) is also maintained. Thus, for example, the medication-containing container 1 is easy to grip.

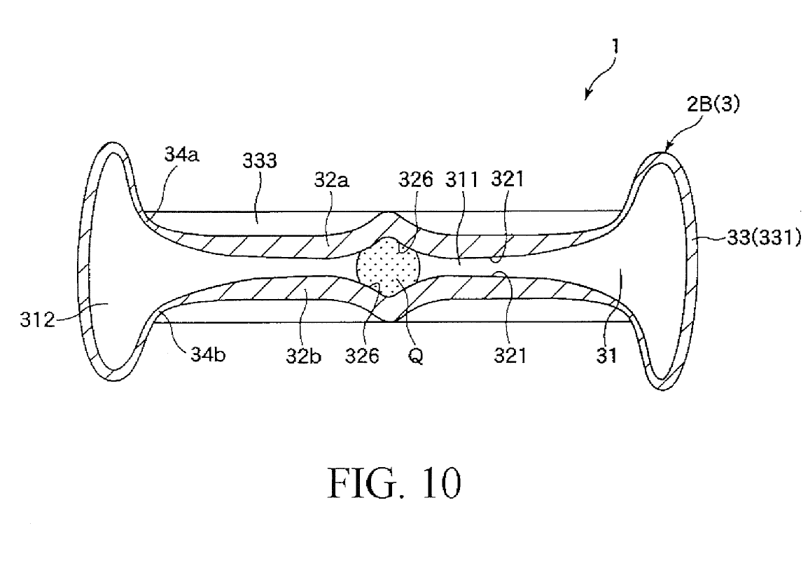

Additionally, the frame section 33 is so formed as to surround the whole periphery of the flat section 32a (and the flat section 32b, as well) which is rectangular in plan view, as above-mentioned. Therefore, the frame section 33 can be divided into side parts 331 located on the long sides of the flat section 32a, and a distal end part 332 and a proximal end part 333 located on the short sides of the flat section 32a. The side parts 331, the distal end part 332 and the proximal end part 333 are each “C”-shaped in cross section (see FIG. 10).

In the initial state, a ring-shaped side space 312 surrounded by the inner surface of the frame section 33 has a size (the length indicated by average distance d0 in FIG. 4) greater than the size (gap distance d1) of the flat plate-shaped gap 311. Thus, the dissolving liquid R flowing into the barrel section 3 in the initial state flows more preferentially through the side space 312 than through the gap 311, inside the barrel section 3. Consequently, in the case where the medication Q is located mainly in the side space 312 as shown in FIG. 4, the medication Q can reliably make contact with the dissolving liquid R and, hence, is dissolved with the dissolving liquid R. In addition, the dissolving liquid R flowing through the side space 312 passes through the gap 311. Thus, the dissolving liquid R flows throughout the internal space 31 and, hence, the medication Q is stirred and dissolved with the dissolving liquid R.

As shown in FIG. 3, in the initial state, the flat sections 32a and 32b are each located within the range of width w of the frame section 33 in side view. Accordingly, the medication-containing container 1 is flat in shape in the initial state, and even in such a flat shape, the dissolving liquid R can be introduced into the medication-containing container 1 reliably.

In addition, the frame section 33 is so shaped that both side parts 331 thereof gradually decrease in width w toward the proximal end direction. This ensures that the internal volume in the initial state can be made smaller.

The extent of the gradual decrease of the frame section 33, namely, the angle θ2 in FIG. 3 is not particularly limited, and is, for example, preferably 0.1 to 60 degrees, more preferably 0.1 to 45 degrees. Incidentally, the angle θ2 may be 0 degrees.

As shown in FIG. 3, the frame section 33 has, at the distal end part 332, a guide part 334 in which the width of a space surrounded by an inner surface thereof gradually decreases along the proximal end direction. When the dissolving liquid R flows into the container body through the mouth section 7, the dissolving liquid R is easily guided into the gap 311 by the guide part 334.

The flat section 32a has its outer peripheral portion connected to an upper portion of the frame section 33 through the easily-deformable section 34a, and the flat section 32b has its outer peripheral portion connected to a lower portion of the frame section 33 through the easily-deformable section 34b.

As shown in FIG. 4, the easily-deformable sections 34a and 34b are located on the inner side of the frame section 33 in the initial state and are in a belt-like shape along the circumferential direction of the frame section 33.

As shown in FIG. 4, the thickness (material thickness) t2 (average) of the frame section 33 is smaller than the thickness (material thickness) t1 (average) of the flat section 32a (and of the flat section 32b, as well). In addition, the thickness (material thickness) t3 (average) of the easily-deformable section 34a (and of the easily-deformable section 34b, as well) is equal to or smaller than the thickness t2 of the frame section 33. In other words, in the container body 2, the modulus of elasticity of the flat section 32a is greater than those of the frame section 33 and the easily-deformable section 34a, and the modulus of elasticity of the frame section 33 is equal to or greater than that of the easily-deformable section 34a.

Such magnitude relations of the thicknesses ensures that the easily-deformable sections 34a, 34b can deform more preferentially (easily) than the flat sections 32a, 32b and the frame section 33. Thus, in the medication-containing container 1, parts to be deformed are specified. Thus, when the medication-containing container 1 changes in state from the initial state to the dissolving liquid-filled state and then deforms, the gap 311 and the side space 312 can be reliably prevented from being reduced in size during this process. Consequently, the dissolving liquid R can be sufficiently introduced (injected) into the medication-containing container 1.

Incidentally, the thickness t1 is not particularly limited, and is, for example, preferably 0.2 to 1 mm, more preferably 0.3 to 0.8 mm. The thickness t2 (and the thickness t3, as well) is not specially restricted, and is, for example, preferably 0.05 to 0.9 mm, more preferably 0.1 to 0.7 mm. Also, the difference between the thickness t1 and the thickness t2 is not particularly limited, and is, for example, preferably 0.05 to 0.8 mm.

In addition, the distance d2 in FIG. 3 of a space surrounded by the distal end part 332 of the frame section 33 and the easily-deformable sections 34a and 34b, in the side space 312, is not particularly limited, and is, for example, preferably equal to or slightly greater than the maximum inside diameter φd5 of the mouth section 7. The magnitude of the maximum inside diameter φd5 is not particularly limited, and is, for example, preferably 5 to 30 mm, more preferably 10 to 20 mm.

Further, the distance d3 in FIG. 3 of a space surrounded by the proximal end part 333 of the frame section 33 and the easily-deformable sections 34a and 34b, in the side space 312, is not particularly limited, and is, for example, preferably 1 to 100 mm, more preferably 2 to 50 mm. In addition, the distance d4 in FIG. 3 is not particularly limited, and is, for example, preferably 1 to 50 mm, more preferably 4 to 25 mm. Still further, the inclination angle θ1 in FIG. 3 of the easily-deformable section 34a relative to the flat section 32a is not particularly limited, and is, for example, preferably 90 to 180 degrees, more preferably 120 to 180 degrees.

The container body 2 (inclusive of the barrel section 3 and part (a tubular part 72) of the mouth section 7) is formed from a flexible material, more specifically, a flexible resin material. The flexible resin material is not particularly limited, and examples thereof include polyolefins such as polyethylene, polypropylene, polybutadiene, ethylene-vinyl acetate copolymer (EVA), etc., polyesters such as polyethylene terephthalate (PET), polybutylene terephthalate (PBT), etc., various thermoplastic elastomers such as flexible polyvinyl chloride, polyvinylidene chloride, silicone, polyurethane, polyamide elastomers, etc., and arbitrary combinations (blend resins, polymer alloys, laminates, etc.) of these materials. In addition, the barrel section 3 may be composed of a single layer or may be composed of a laminate in which a plurality of layers are laminated.

Besides, the container body 2 formed from such a flexible resin material is produced by blow-molding (integral molding). By blow molding, the inner surface of the container body 2 can be made smooth. In the case of a conventional medication-containing container obtained, for example, by fusion-bonded edge portions of two sheet materials, a medication Q may stagnate in the vicinity of the fusion-bonded portion so that the medication Q can not make contact with a dissolving liquid R. In contrast, in the case of the container body 2 produced by blow-molding, such a trouble can be prevented from occurring.

At the distal end side of the medication-containing container 1, there is disposed the mouth section 7 through which the dissolving liquid R flow in and/or the medicinal liquid P flows out. As shown in FIGS. 3 and 5, a valve body 5 made of an elastic material and having a self-closing property is mounted (contained) in the mouth section 7.

The mouth section 7 has a tubular part 72 formed integrally with the distal end part 332 of the frame section 33 and tubular in shape, and a cap part 73 mounted to the tubular part 72.

The tubular part 72 is formed therein with a valve mounting part 721. The valve mounting part 721 can be divided into a second inner cavity part (inner cavity part) 723, and a third inner cavity part (inner cavity part) 724 located on the proximal end side relative to the second inner cavity part 723, the inside diameter of the third inner cavity part 724 being smaller than that of the second inner cavity part 723. In addition, the inside diameter of the third inner cavity part 724 is preferably slightly greater than the maximum outside diameter of a trunk part 55 of the valve body 5 which will be described later.

Also, at a central portion of a bottom surface 722 of the tubular part 72, there is provided an inside projection 725 composed of a tubular body. When the valve body 5 starts being pressed as shown in FIG. 5, the inside of the valve body 5 is supported by the inside projection 725, whereby it is possible to prevent the valve body 5 from buckling (the valve body 5 from bending into a dogleg shape). In addition, when the dissolving liquid R passes through the mouth section 7, the dissolving liquid R can be prevented from stagnating there.

The cap part 73 has therein a space (inner cavity part) in which to contain the valve body 5, and is connected (mounted) to the tubular part 72 (valve mounting part 721). The cap part 73 is made of a rigid resin material, for example.

The cap part 73 has therein a first inner cavity part 731 in which a head part 50 of the valve body 5, to be described later, can be inserted, and a fitting part 733 communicating with the first inner cavity part 731, the fitting part 733 having an enlarged diameter as compared with the first inner cavity part 731.

The first inner cavity part 731 is formed to have a shape corresponding to the outer shape of the head part 50 of the valve body 5.

Further, the fitting part 733 is part to be fitted around an outer peripheral portion of the tubular part 72. Thus, the cap part 73 and the tubular part 72 are connected to each other liquid-tightly, so that the dissolving liquid R inside the mouth section 7 can be prevented from leaking through a gap between the cap part 73 and the tubular part 72. In addition, when the cap part 73 and the tubular part 72 are connected to each other, the first inner cavity part 731 and the second inner cavity part 723 communicate with each other, so that the valve body 5 can be placed (contained) in a space formed by the first inner cavity part 731, the second inner cavity part 723 and the third inner cavity part 724.

An outer peripheral portion of the cap part 73 is formed with a male screw part 738. In the mouth section 7, the male screw part 738 is screw-engaged with a female screw part 903 formed at an inner peripheral portion of a tubular lock part 902 provided concentrically with a mouth part 901 of a prefilled syringe 90 which will be described later (see FIG. 5).

In the mouth section 7 with such a configuration, a space (inner cavity part) in the inside thereof functions as a flow path through which the dissolving liquid R can pass.

As shown in FIGS. 3 and 5, the valve body 5 is contained (fixed) in the mouth section 7.

The valve body 5 is made of an elastic material. The elastic material may include various rubber materials such as natural rubber, isoprene rubber, butadiene rubber, styrene-butadiene rubber, nitrile rubber, chloroprene rubber, butyl rubber, acrylic rubber, ethylene-propylene rubber, hydrin rubber, urethane rubber, silicone rubber, fluoro-rubber, etc. and various thermoplastic elastomers based on styrene, polyolefin, polyvinyl chloride, polyurethane, polyester, polyamide, polybutadiene, trans-polyisoprene, fluoro-rubber, chlorinated polyethylene or the like. One of these materials or two or more of these materials in mixture may be used. With such an elastic material used, a top face (distal end face) 511 of the valve body 5 can have appropriate elasticity. Thus, when the prefilled syringe 90 is connected to the mouth section 7, an end face of the prefilled syringe 90 and the top face 511 can make liquid-tight contact with each other (see FIG. 5).

The valve body 5 has the tubular trunk part 55, and the head part 50 integrally provided at one end portion of the trunk part 55.

The head part 50 has a bottomed tube-like shape, and has an inner cavity part 515 permitting the dissolving liquid R and the medicinal liquid P to pass therethrough, and a slit (opening-closing part) 512 extending from the flat top face 511 to the inner cavity part 515. The slit 512 has a substantially straight-line-like shape. Since the slit 512 is simple in shape as above, pressing of the top face 511 (the vicinity of the slit 512) causes the top face 511 to deform, so that the slit 512 is opened easily (reliably). In addition, when the pressing is released, the top face 511 is restored, so that the slit 512 is closed assuredly. Thus, the valve body 5 has self-closing property.

In addition, by such an operation of the slit 512, an opening part of the mouth section 7 can be sealed (see FIG. 3)/unsealed (see FIG. 5) easily and reliably.

Also, since the top face 511 is flat in shape, the top face 511 (slit 512) can be easily disinfected in the case of connecting the prefilled syringe 90 thereto.

In addition, when the above-mentioned pressing force is not exerted thereon, the head part 50 is inserted in the first inner cavity part 731 of the cap part 73, and the slit 512 is kept closed.

The trunk part 55 is composed of a bellows-like tubular body. More specifically, the trunk part 55 has a bellows-like outer shape in which large-diameter ring parts 552 and small-diameter ring parts 553 are alternately arrayed along the axial direction. The trunk part 55 thus configured functions as a deforming part (biasing means) for biasing the valve body 5 from the trunk part 55 side toward the head part 50 side (in the direction in which the head part 50 is inserted into the first inner cavity part 731 of the cap part 73).

Since the trunk part 55 thus functions as a deforming part, it is unnecessary to separately provide, at the mouth section 7, a component for constituting a biasing means. This contributes to a reduction in the number of components and to simplification of structure.

In addition, the trunk part 55 serves most of the function of applying restoring force for restoring the valve body 5 from the trunk part 55 side toward the head part 50 side, and also the head part 50 may serve part of the function of applying the restoring force.

In the container body 2 configured as above, the medication Q is contained. The medication Q is not particularly limited. The medication Q may include medications which are dangerous if erroneously touched by a medical worker, such as carcinostatic, immunosuppressant, etc., medications which need dissolution in use, such as antibiotic, styptic, etc., medications which need dilution, such as pediatric drugs, etc., medications which needs multi-time dispensing, such as vaccine, heparin, pediatric drugs, etc.

In addition, a medication Q is obtained by freeze-drying a liquid composition containing the medication Q. By use of freeze-drying, the medication Q can be reliably dried, regardless of the kind of the medication Q. Also, in the case where the liquid composition is dried in the container body 2 in manufacturing the medication-containing container 1, the medication Q obtained by drying the liquid composition can be retained in the side space 312 in the container body 2 (barrel section 3). Further, in the case where the medication Q is obtained by freeze-drying a liquid composition containing the medication Q in manufacturing the medication-containing container, the area of contact between the flat section 32a and the support base on which to place the container body 2 can be secured to such an extent that heat from the flat section 32a or 32b can be sufficiently absorbed (cooled).

The dissolving liquid R for dissolving the medication Q is introduced into the medication-containing container 1 by use of the prefilled syringe 90. The dissolving liquid R is not particularly limited, and may include physiological saline.

The prefilled syringe 90 has a syringe outer tube having a mouth part 901 projectingly formed at an end portion (proximal end portion) thereof, a tubular lock part 902 disposed at an outer peripheral portion of the mouth part 901 concentrically with the mouth part 901, a gasket (not shown) slidable inside the syringe outer tube along the longitudinal direction thereof, and a plunger (not shown) operable for moving the gasket. A space surrounded by the syringe outer tube and the gasket is filled with the dissolving liquid R. The dissolving liquid R flows out via the mouth part 901 of the syringe outer tube by pushing the plunger.

Now, an example of the usage of the medication-containing container 1 will be described in detail below.

[1] First, the medication-containing container 1 in the initial state (the state shown in FIG. 1) and the prefilled syringe 90 filled with the dissolving liquid R are prepared.

[2] Next, the mouth section 7 of the medication-containing container 1 and the lock part 902 of the prefilled syringe 90 are screw-engaged with each other, thereby connecting the medication-containing container 1 and the prefilled syringe 90 to each other (see FIG. 5). In this instance, the mouth part 901 of the prefilled syringe 90 presses (compresses) the valve body 5 in the mouth section 7 of the medication-containing container 1 toward the proximal end side. As a result, the slit 512 of the valve body 5 is brought into the open state as above-mentioned and then the inside of the medication-containing container 1 and the inside of the prefilled syringe 90 communicate with each other.

[3] Subsequently, the plunger of the prefilled syringe 90 is pushed. Then, the dissolving liquid R in the prefilled syringe 90 is injected into the medication-containing container 1 through the mouth section 7 of the medication-containing container 1 (see FIG. 5). The dissolving liquid R thus-injected passes through the side space 312, so that the whole part of the side space 312 is filled with the dissolving liquid R. Then, the dissolving liquid R gradually flows into the gap 311, to fill the whole part of the gap 311. As a result, the internal space 31 of the medication-containing container 1 is entirely filled with the dissolving liquid R. Also, in this instance, the dissolving liquid R pushes the flat sections 32a and 32b outward, so that the easily-deformable sections 34a and 34b deform and, therefore, the flat sections 32a and 32b are separated further away from each other. As a result, the volume of the internal space 31 of the medication-containing container 1 is increased. Thus, in the medication-containing container 1, the dissolving liquid R can be introduced into the medication containing container 1 to fill the medication containing container 1 easily and reliably. In addition, the introduced dissolving liquid R can be made sufficient in quantity for dissolving the medication Q.

Also, even if the dissolving liquid R is introduced, since the volume of the internal space 31 is increased, rise in the pressure inside the internal space 31 of the medication-containing container 1 can be suppressed. In addition, the amount of the introduced dissolving liquid R can be set to be not more than the maximum volume of the internal space 31 of the medication-containing container 1.

[4] Next, the entire medication-containing container 1 with the prefilled syringe 90 connected thereto is shaken. This results in more reliable dissolution of the medication Q with the dissolving liquid R.

[5] Subsequently, the plunger of the prefilled syringe 90 is pulled. Thus, the medicinal liquid P in the medication-containing container 1 is sucked into the prefilled syringe 90. The suction amount of the medicinal liquid P can be appropriately adjusted according to the pulling amount of the plunger of the prefilled syringe 90.

### Second Embodiment

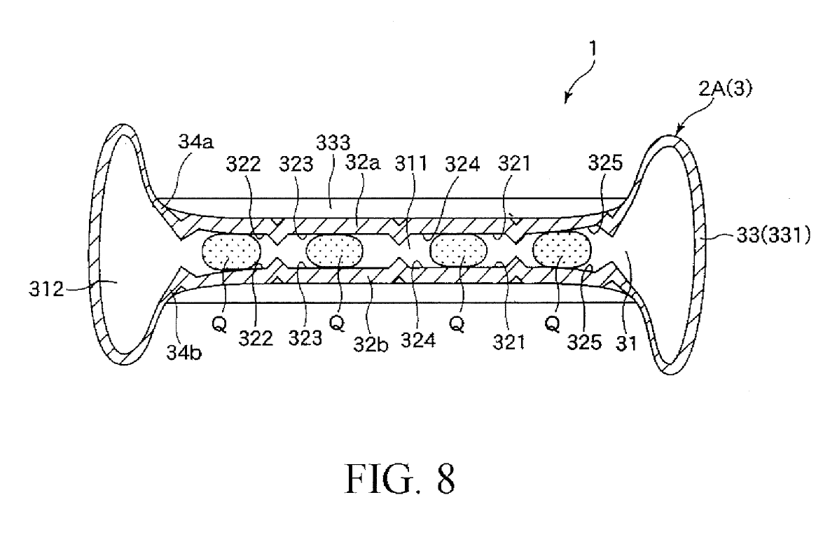

FIG. 7 is a perspective view of a second embodiment of the medication-containing container according to the present invention, and FIG. 8 is a sectional view taken along line E-E of FIG. 7.

Now, with reference to these drawings, the second embodiment of the medication-containing container according to the present invention will be described below. The following description will focus on differences from the above-described embodiment, and description of the same items as above will be omitted.

This embodiment is the same as the above-described first embodiment, except for difference in the shape of the container body.

In a container body 2A shown in FIGS. 7 and 8, a plurality of (four in this embodiment) grooves 322, 323, 324 and 325 are formed in inner surfaces 321 of flat sections 32a and 32b. The grooves 322 to 325 are formed along the longitudinal direction of the medication-containing container 1. In addition, as shown in FIG. 8, in the initial state, a medication Q is located mainly in the grooves 322 to 325.

Upon flowing-in of a dissolving liquid R through the mouth section 7, the dissolving liquid R first passes through the side space 312. Then, the dissolving liquid R having passed through the side space 312 reaches a proximal end portion of the medication-containing container 1, whereon it can flow through the grooves 322 to 325 toward the mouth section 7 side. In this instance, the dissolving liquid R can reliably make contact with the medication Q located in the grooves 322 to 325, so that the medication Q can be dissolved reliably.

As a result, the medicinal liquid P flows through the grooves 322 to 325 toward the mouth section 7 side, so that the medicinal liquid P can be flowed back into the prefilled syringe 90 promptly.

Each of such grooves 322 to 325 functions as flow direction regulating means for regulating the flow direction of the liquid (the dissolving liquid R, the medicinal liquid P).

Incidentally, the number of the grooves formed in each of the flat sections 32a and 32b is not limited to four, and may for example be two, three, or not less than five.

In addition, the lengths of the grooves 322 to 325 may be the same or different.

Also, the present embodiment is not limited to the above configuration in which the flat sections 32a and 32b are each provided with the grooves 322 to 325, and only one of the flat sections 32a and 32b may be formed with the grooves 322 to 325.

### Third Embodiment

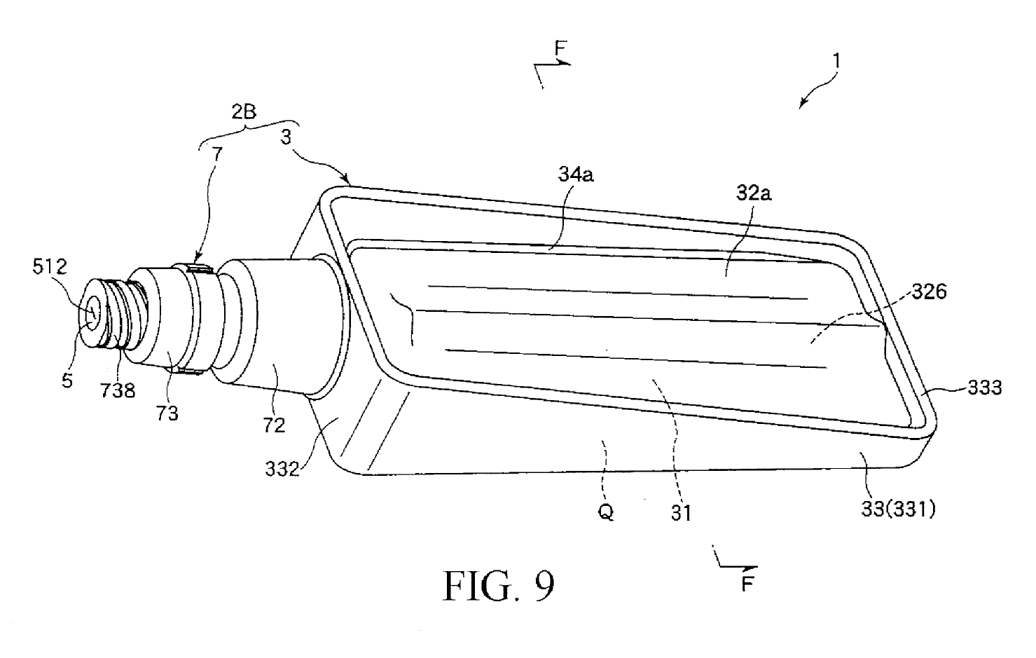

FIG. 9 is a perspective view of a third embodiment of the medication-containing container according to the present invention, and FIG. 10 is a sectional view taken along line F-F of FIG. 9.

Now, with reference to these drawings, the third embodiment of the medication-containing container according to the present invention will be described below. The following description will focus on differences from the above-described embodiments, and descriptions of the same items as above will be omitted.

This embodiment is the same as the above-described second embodiment, except for difference in the number of grooves formed in the container body.

In a container body 2B shown in FIGS. 9 and 10, one groove 326 is formed in each of inner surfaces 321 of flat sections 32a and 32b. The groove 326 is located at a central portion in the width direction of the container body 2B. This groove 326 is greater in width and depth than each of the grooves 322 to 325 in the second embodiment. More specifically, the groove 326 has a cross-sectional area of preferably 0.03 to 15 cm², more preferably 0.05 to 2 cm². In addition, as shown in FIG. 10, in the initial state, a medication Q is located mainly in the groove 326.

Upon flowing-in of a dissolving liquid R through a mouth section 7, the dissolving liquid R first passes more preferentially through the groove 326 than through a side space 312. In this instance, the dissolving liquid R can reliably make contact with the medication Q located in the groove 326, so that the medication Q can be dissolved assuredly. Then, the dissolving liquid R (medicinal liquid P) having passed through the groove 326 reaches a proximal end portion of the medication-containing container 1, whereon it can pass through the side space 312 and then flow toward the mouth section 7 side.

In the container body 2B, the flow of liquid is regulated to one direction, and, therefore, the medicinal liquid P can be speedily recovered into a prefilled syringe 90.

### Fourth Embodiment

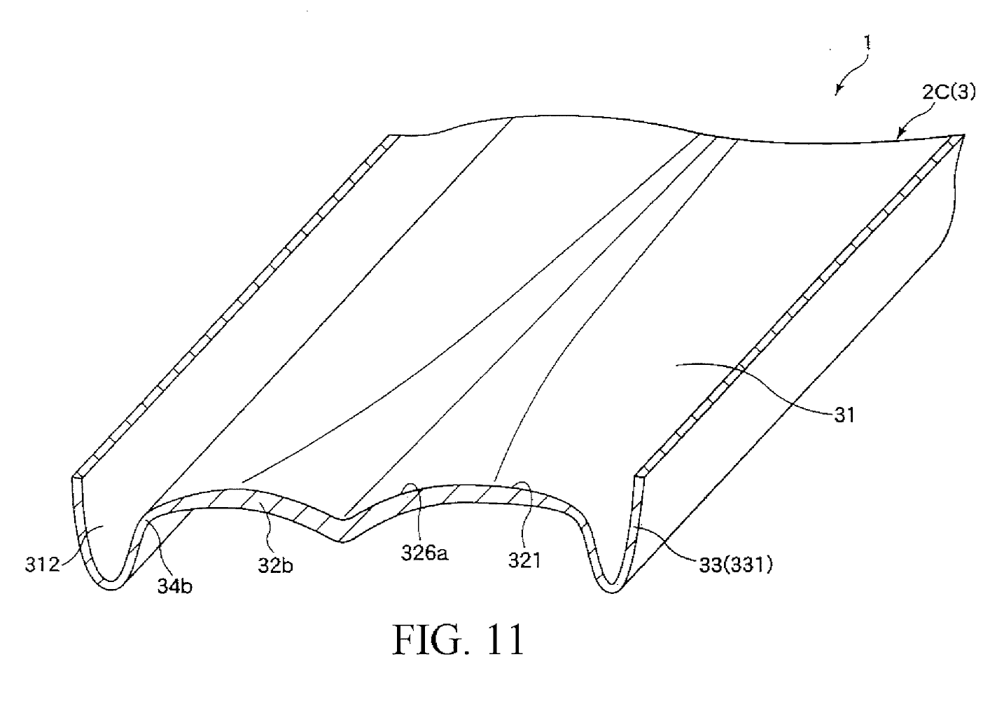

FIG. 11 is a sectional perspective view of a fourth embodiment of the medication-containing container according to the present invention.

Now, with reference to this drawing, the fourth embodiment of the medication-containing container according to the present invention will be described below. The following description will focus on differences from the above-described embodiments, and descriptions of the same items as above will be omitted.

This embodiment is the same as the above-described third embodiment, except for difference in the shape of the groove in the container body.

In a container body 2C shown in FIG. 11, a groove 326a gradually decreases (varies) in depth and width along the longitudinal direction thereof. Thus, upon flowing-in of a dissolving liquid R via a mouth section 7, the dissolving liquid R can be reliably guided into the groove 326a. Accordingly, the dissolving liquid R can pass more preferentially through the groove 326a than through a side space 312.

### Fifth Embodiment

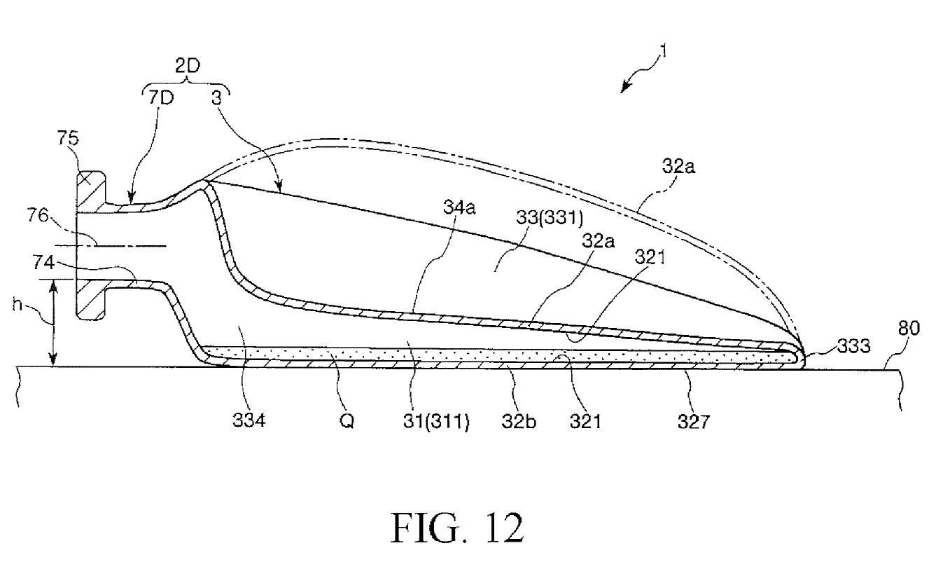

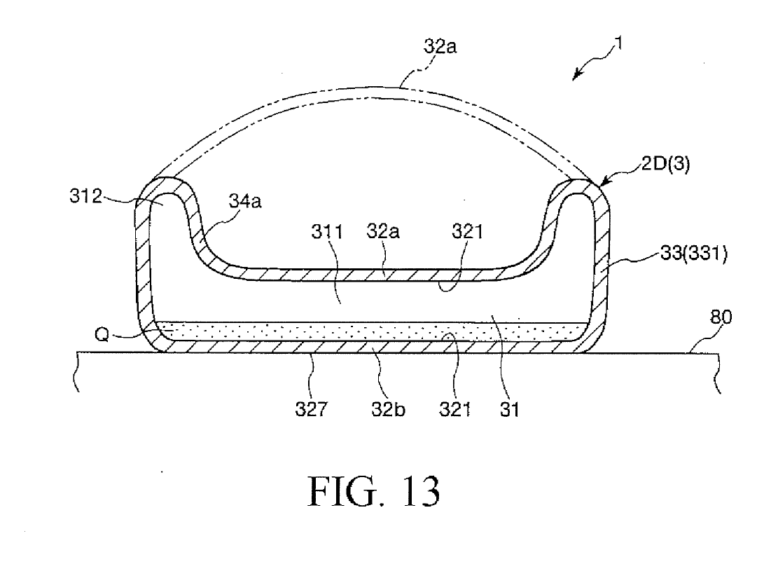

FIG. 12 is a longitudinal sectional view of a fifth embodiment of the medication-containing container according to the present invention, and FIG. 13 is a cross-sectional view of the fifth embodiment of the medication-containing container according to the present invention.

Now, with reference to these drawings, the fifth embodiment of the medication-containing container according to the present invention will be described below. The following description will focus on differences from the above-described embodiments, and descriptions of the same items as above will be omitted.

This embodiment is the same as the above-described first embodiment, except for difference in the number of easily-deformable sections.

In a container body 2D shown in FIGS. 12 and 13, unlike the container body 2 in the first embodiment, an easily-deformable section 34a is provided only on the side of a flat section 32a (on the upper side). Therefore, upon flowing-in of a dissolving liquid R via a mouth section 7D of the container body 2D, the easily-deformable section 34a deforms, and then the container body 2D is expanded until the flat section 32a is displaced to a profile indicated by the two-dotted chain line in the drawings.

In this container body 2D, the flat section 32b functions as a mounting part (mounting surface) at the time when the container body 2D is placed on a support base 80 such as, for example, a table. Thus, the container body 2D can be stably placed on the support base 80, irrespectively of the initial state and the liquid-filled state of the container body 2D.

Also, in the condition where the container body 2D is placed on the support base 80 with its flat section 32b on the lower side, a medication Q is located, in an unevenly distributed manner, on the lower side (on the flat section 32b) inside the container body 2D (see FIGS. 12 and 13).

In addition, when the container body 2D is placed on the support base 80, substantially the whole part of a lower surface 327 of the flat section 32b makes contact with the support base 80. In the case where the medication Q is obtained by freeze drying a liquid composition containing the medication Q in manufacturing the medication-containing container 1, the area of contact between the flat section 32b and the support base 80 can be secured to such an extent that heat from the liquid composition can be sufficiently absorbed (cooled) through the flat section 32b. Further, since the contact of the liquid composition with the flat section 32a enlarges the outer surface area of the liquid surface, efficient drying can be achieved. Consequently, the medication-containing container 1 can be manufactured speedily and reliably.

The mouth section 7D is tubular in shape, projecting from a distal end portion of the container body 2D. The axis line 76 of the mouth section 7D is horizontal when the container body 2D is placed on the support base 80. In this instance, the height h from the support base 80 to a lower portion 74 of an inner peripheral surface of the mouth section 7D is, for example, preferably 2 to 30 mm, more preferably 5 to 20 mm. Thus, the liquid composition can be prevented from unwillingly flowing out (leaking out) via the mouth section 7D when the container body 2D containing the liquid composition therein is placed on the support base 80.

In addition, as shown in FIG. 12, preferably the mouth section 7D has, at an outer peripheral portion of the distal end thereof, a flange part 75 with an enlarged outside diameter.

### Sixth Embodiment

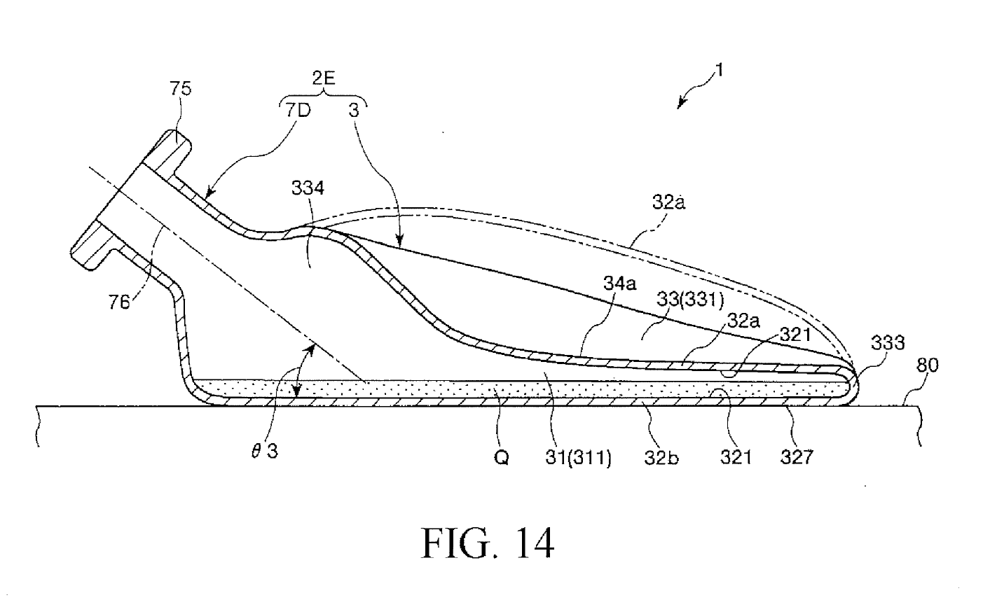

FIG. 14 is a longitudinal sectional view of a sixth embodiment of the medication-containing container according to the present invention.

Now, with reference to this drawing, the sixth embodiment of the medication-containing container according to the present invention will be described below. The following description will focus on differences from the above-described embodiment, and descriptions of the same items above will be omitted.

This embodiment is the same as the above-described fifth embodiment, except for difference in the opening direction of the mouth section of the container body.

In a container body 2E shown in FIG. 14, a mouth section 7D is open obliquely upward in the drawing when the container body 2E is placed on a support base 80. In this case, the inclination angle θ3 of the axis line 76 of the mouth section 7D relative to the support base 80 is not particularly limited, and is, for example, preferably 1 to 90 degrees, more preferably 1 to 45 degrees. Thus, the liquid composition can be prevented from unwillingly flowing out (leaking out) via the mouth section 7D when the container body 2E containing the liquid composition therein is placed on the support base 80.

Although the medication-containing container according to the present invention has been described above with reference to the embodiments shown in the drawings, the invention is not limited to the above embodiments, and components of the medication-containing container can be replaced with those of arbitrary configurations that can exhibit the similar functions. Also, an arbitrary structure or structures may be added thereto.

In addition, the medication-containing container of the present invention may be a combination of any two or more of configurations (features) of the above-described embodiments.

Also, the container body is not limited to the one that is produced by blow molding, and, for example, may be produced by joining (fusion-bonding) container body halves to each other.

In addition, although the flat sections are each located at a substantially central part in the width direction of the frame section in the initial state, the present invention is not limited to this configuration; for example, each flat section may be located on one side in the width direction of the frame section.

Further, the medication-containing container may preliminarily be filled with an inert gas such as, for example, nitrogen, in the initial state. This makes it possible to prevent oxidation of a medication, though depending on the kind of medication.

In addition, although the valve body is mounted into the mouth section of the medication-containing container in each of the above embodiments, the present invention is not limited to this configuration; the valve body may be omitted.

Still further, although the medication to be contained is a powdery one in each of the above embodiments, the present invention is not limited to this configuration; for example, the medication may be in the form of tablet, gel, or liquid.

In addition, in the container body, the frame section is not limited to the one that surrounds the whole peripheries of the flat sections; for example, the frame section may have a lost part thereof (for example, at a proximal end portion).

### INDUSTRIAL APPLICABILITY

The medication-containing container according to the present invention includes a container body having, at the distal end side thereof, a mouth section through which a liquid can flow into and out of the container body, and the container body being made of a flexible material, and a medication contained in the container body and which is dissolved with the liquid that has flowed into the container body through the mouth section; wherein the container body includes: a pair of flat sections being flat and facing each other with a gap therebetween in an initial state in which no liquid is contained in the container body, a frame section provided on outer peripheries of the flat sections, and an easily-deformable section which interconnects the frame section and at least one of the flat sections, and which is easily deformable; and when the liquid is introduced into the container body, the easily-deformable section deforms to cause the flat sections to separate further from each other than in the initial state, so that the container body increases in volume. Therefore, the container body can be easily filled with the liquid, and the medication can be reliably dissolved with the liquid contained in the container body. Accordingly, the medication-containing container of the present invention has industrial applicability.

1. A medication-containing container comprising a container body having, at a distal end side thereof, a mouth section through which a liquid can flow into and out of the container body, the container body being made of a flexible material, and a medication contained in the container body and which is dissolved with the liquid that has flowed into the container body through the mouth section,
wherein the container body is integrally molded, and when the liquid is introduced into the container body, the container body deforms and increases in volume.

2. A medication-containing container comprising a container body having, at a distal end side thereof, a mouth section through which a liquid can flow into and out of the container body, the container body being made of a flexible material, and a medication contained in the container body and which is dissolved with the liquid that has flowed into the container body through the mouth section;
wherein the container body comprises:
a pair of flat sections being flat and facing each other with a gap therebetween in an initial state in which no liquid is contained in the container body,
a frame section provided on outer peripheries of the flat sections, and
an easily-deformable section which interconnects the frame section and at least one of the flat sections, and which is easily deformable; and
when the liquid is introduced into the container body, the easily-deformable section deforms to cause the flat sections to separate further from each other than in the initial state, so that the container body increases in volume.

3. The medication-containing container according to claim 2, wherein in the initial state, each of the flat sections is located within a range of the width of the frame section in side view.

4. The medication-containing container according to claim 2, wherein the container body is formed such that the average thickness of a portion thereof where the frame section is formed, is smaller than the average thickness of portions thereof where the flat sections are formed.

5. The medication-containing container according to claim 2, wherein the container body is formed such that the average thickness of a portion thereof where the easily-deformable section is formed, is smaller than the average thickness of a portion thereof where the frame section is formed.

6. The medication-containing container according to claim 2, wherein the container body further has flow direction regulating means for regulating a flow direction of the liquid that has flowed into the container body through the mouth section.

7. The medication-containing container according to claim 6, wherein the flow direction regulating means comprises at least one groove extending from the distal end side to a proximal end side in an inner portion of at least one of the flat sections.

8. The medication-containing container according to claim 1, wherein the mouth section is fitted with a valve body made of an elastic material and which has an opening-closing section which is openable and closable.
